(19) United States
(12) Patent Application Publication
(10) Pub. No.: US 2023/0300250 A1
(43) Pub. Date: Sep. 21, 2023

(54) SELECTIVELY PROVIDING AUDIO TO SOME BUT NOT ALL VIRTUAL CONFERENCE PARTICIPANTS REPRSENTED IN A SAME VIRTUAL SPACE

(71) Applicant: Lenovo, Morrisville, NC (US)

(72) Inventors: Mark Delaney, Raleigh, NC (US); John C. Mese, Cary, NC (US); Arnold Weksler, Raleigh, NC (US); Nathan Peterson, Oxford, NC (US); Russell Speight VanBlon, Raleigh, NC (US)

(21) Appl. No.: 17/696,618

(22) Filed: Mar. 16, 2022

(51) Int. Cl. H04M 3/56; H04N 7/15; H04N 7/14

(52) U.S. Cl. CPC H04M 3/568; H04M 3/567; H04N 7/152; H04N 7/147; H04N 7/157

(57) ABSTRACT

In one aspect, an apparatus may include a processor and storage accessible to the processor. The storage may include instructions executable by the processor to facilitate a virtual conference between first, second, and third participants that may be remotely located from each other. The virtual conference may place respective representations of the participants into a same virtual space. The instructions may also be executable to determine that the first participant performs a gesture such as leaning in relation to the second participant according to locations of the first and second participants in the virtual space. Based on the determination, the instructions may be executable to selectively provide audio of the first participant speaking from a first client device to a second client device of the second participant but not provide the audio from the first client device to a third client device of the third participant.

### FIELD

The disclosure below relates to technically inventive, non-routine solutions that are necessarily rooted in computer technology and that produce concrete technical improvements. In particular, the disclosure below relates to techniques for selectively providing audio to some but not all virtual conference participants that are represented in a same virtual space.

### BACKGROUND

As recognized herein, virtual environments such as virtual conferences present a unique set of issues that do not necessarily arise with real-world, in-person interactions. As further recognized herein, among these issues is that often times one participant of a virtual conference might wish to side-conference with another participant without other participants hearing. However, current electronic systems do not adequately provide for such capability and therefore there are currently no adequate solutions to the foregoing computer-related, technological problem.

### SUMMARY

Accordingly, in one aspect an apparatus includes at least one processor and storage accessible to the at least one processor. The storage includes instructions executable by the at least one processor to facilitate a virtual conference between first, second, and third participants. The first, second, and third participants are remotely located from each other, and the virtual conference places respective representations of the first, second, and third participants into a same virtual space. The instructions are also executable to determine that the first participant gestures toward the second participant according to locations of the first and second participants in the virtual space. Based on the determination, the instructions are executable to stream audio of the first participant speaking from a first client device to a second client device of the second participant but not stream the audio of the first participant speaking from the first client device to a third client device of the third participant.

In certain example embodiments, the instructions may also be executable to, prior to the determination, stream audio from each of the first, second, and third client devices between each other so that the first, second, and third participants are able to hear each other speak as part of the virtual conference.

Also in certain example embodiments, input from at least one inertial sensor may be used to make the determination. The at least one inertial sensor may include a gyroscope, and in some specific examples the apparatus may even include the gyroscope itself.

In various example implementations, the apparatus may include a server that coordinates the transmission of audio and video streams between the first, second, and third client devices as part of the virtual conference. Additionally or alternatively, the apparatus may include the first client device itself, and possibly the second and third client devices as well.

Also note that in some examples, the respective representations of the first, second, and third participants may include respective avatars of the first, second, and third participants. Additionally or alternatively, the respective representations of the first, second, and third participants may include respective camera streams of the respective faces of the first, second, and third participants.

If desired, the virtual space may include a virtual conference room into which the respective representations are placed. For example, the virtual conference room may specifically form part of a virtual reality (VR) environment into which the respective representations are placed.

In another aspect, a method includes facilitating, using an apparatus, a virtual conference between first, second, and third participants. The first, second, and third participants are remotely located from each other, and the virtual conference places respective representations of the first, second, and third participants into a same virtual space. The method also includes determining that the first participant performs a gesture in relation to the second participant according to locations of the first and second participants in the virtual space. Based on the determining that the first participant performs the gesture in relation to the second participant according to the locations of the first and second participants in the virtual space, the method includes streaming first audio of the first participant speaking from a first client device to a second client device of the second participant but not streaming the audio of the first participant speaking from the first client device to a third client device of the third participant.

Thus, in certain examples the gesture may include leaning toward the second participant according to the locations of the first and second participants in the virtual space. Also in certain examples, the method may then include determining that the first participant is no longer leaning toward the second participant and, responsive to determining that the first participant is no longer leaning toward the second participant, streaming second audio of the first participant speaking from the first client device to both the second and third client devices.

Additionally, if desired the method may include determining, based on input from a camera, that the first participant performs the gesture in relation to the second participant according to locations of the first and second participants in the virtual space. The virtual space may form part of a mixed reality (MR) environment into which the respective representations are placed. The respective representations of the first, second, and third participants may include respective virtual characters respectively associated with the first, second, and third participants.

In still another aspect, at least one computer readable storage medium (CRSM) that is not a transitory signal includes instructions executable by at least one processor to facilitate, using an apparatus, a virtual conference between first, second, and third participants. The first, second, and third participants are remotely located from each other, and the virtual conference places respective representations of the first, second, and third participants into a same virtual space. The instructions are also executable to determine that the first participant performs a gesture in relation to the second participant according to locations of the first and second participants in the virtual space. Based on the determination, the instructions are executable to selectively provide first audio of the first participant speaking from a first client device to a second client device of the second participant but not provide the first audio of the first participant speaking from the first client device to a third client device of the third participant.

Accordingly, in certain examples the gesture may include leaning toward the second participant according to the locations of the first and second participants in the virtual space.

Also, in certain example implementations the instructions may be executable to determine that the first participant is no longer performing the gesture toward the second participant according to the locations of the first and second participants in the virtual space. Responsive to the determination that the first participant is no longer performing the gesture in relation to the second participant according to the locations of the first and second participants in the virtual space, the instructions may be executable to provide second audio of the first participant speaking from the first client device to both the second and third client devices.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 illustrates an example headset that may be used for virtual conferencing consistent with present principles;

FIGS. 4 and 5 illustrate a virtual conference, with FIG. 5 further showing how a participant might gesture to enter an isolated audio mode consistent with present principles;

FIG. 6 shows example logic in example flow chart format that may be executed by a device consistent with present principles; and

FIG. 7 shows an example graphical user interface (GUI) that may be presented on a display for configuring one or more settings of a device/metaverse system to operate consistent with present principles.

### DETAILED DESCRIPTION

Among other things, the detailed description below discusses the merging of virtual and physical worlds and isolated virtual interactions within virtual space, providing for robust immersive meetings and workshops between people virtually. A user may thus attend a virtual meeting and the system may emulate a private, natural, and seamless interaction with another user in that virtual space.

Isolated user interactions may occur within the virtual environment based on sensor input from the physical environment and/or device. For instance, input from a tilt sensor/gyroscope may be used to identify a user leaning. In some examples, confidence thresholds may even be used to reduce false positives. The threshold(s) may be set by a user, system administrator, manufacturer, etc.

Also note that in addition to or in lieu of leaning, other gestures may be detected using sensor input to then enter an isolated user interaction mode. For example, detection via a microphone of a user whispering below a threshold decibel level, where the whispering is also detected via a camera as being directed in a direction in the real world that is mapped to a direction/location in the virtual world at which another person is virtually located, may be used as a trigger for an isolated audio interaction between those two.

As another example, detection via camera input and eye tracking software of a user virtually looking into the eyes of another user that is also represented in the virtual world may be used as a trigger for an isolated audio interaction. In some specific examples, both users may be required to look virtually into the eyes of the other at the same time via the virtual world/their virtual characters for triggering the isolated interaction, while in other examples only one user may be required to look virtually into the eyes of the other one (even if the latter is not looking back) for triggering the isolated interaction (e.g., where at least audio of the former is only transmitted to the latter and not others, and possibly audio from the latter is also transmitted back only to the former and not others).

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

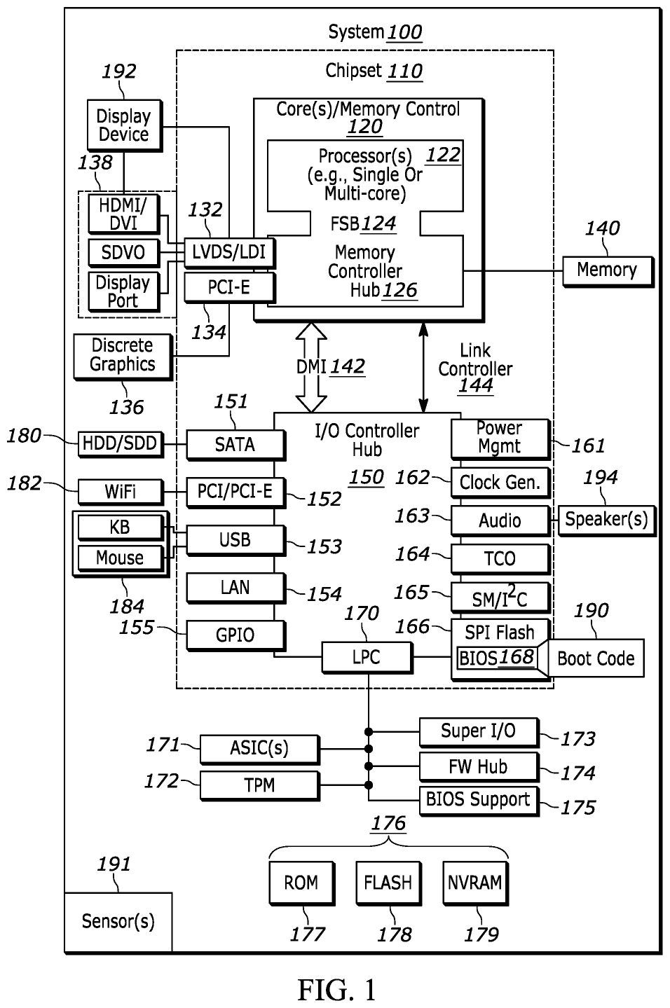

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include one or more sensors 191. The sensors 191 may include, for example, one or more cameras that gather images and provide the images and related input to the processor 122. The camera(s) may be webcams and/or digital cameras, but may also be thermal imaging cameras, infrared (IR) cameras, three-dimensional (3D) cameras, and/or cameras otherwise integrated into the system 100 and controllable by the processor 122 to gather still images and/or video. Thus, for example, a camera might be on a headset being worn by a user so that the system 100 may execute computer vision using images from the camera consistent with present principles. However, note that other cameras that might be used consistent with present principles include stand-alone cameras and cameras located elsewhere within the user's local environment but that still communicate wiredly or wirelessly with the system 100 (including, for example, cameras located on other devices like a user's nearby smartphone). Regardless, the computer vision software that is executed using images from one or more of the foregoing cameras may be Amazon's Rekognition or Google's Cloud Vision API, for example.

In addition to or in lieu of the foregoing, the sensors 191 may include one or more inertial measurement sensors that might be included in an inertial measurement unit (IMU). For example, the system 100 may be embodied in a headset and the inertial measurement sensors may be located on the headset. Example inertial measurement sensors include magnetometers that sense and/or measure directional movement of the system 100 and provide related input to the processor 122, gyroscopes that sense and/or measure the orientation of the system 100 and provide related input to the processor 122, and accelerometers that sense acceleration and/or movement of the system 100 and provide related input to the processor 122.

The one or more sensors 191 might also include other sensors that can sense head and torso movements of a user and other gestures consistent with present principles, such as light detection and ranging (LIDAR) sensors, other types of time of flight sensors (such as ultrasonic time of flight sensors), etc. But regardless of the type used, it is to be understood that one or more of the sensors 191 may be used for determining gestures as described herein consistent with present principles.

Additionally, though not shown for simplicity, in some embodiments the system 100 may include an audio receiver/microphone that provides input from the microphone to the processor 122 based on audio that is detected, such as via a user providing audible input to the microphone as part of a virtual conference as described herein. The system 100 may also include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

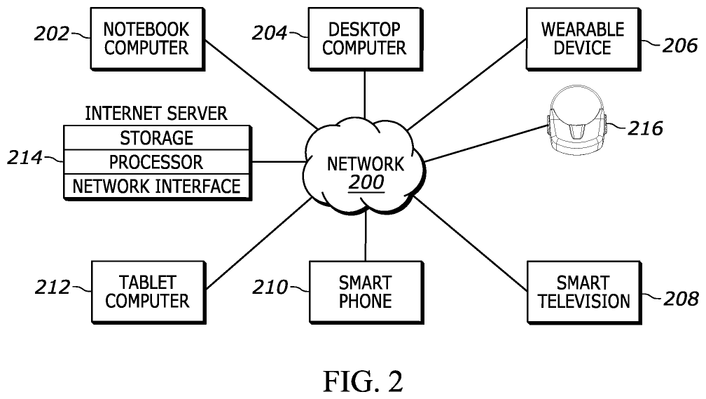

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a headset 216, and a server 214 such as an Internet server that may provide cloud storage accessible to the devices 202-212, 216. It is to be understood that the devices 202-216 may be configured to communicate with each other over the network 200 to undertake present principles (e.g., to participate in a virtual conference). Note that, consistent with present principles, the devices shown in FIG. 2 may all be remotely-located from each other by tens of miles or more.

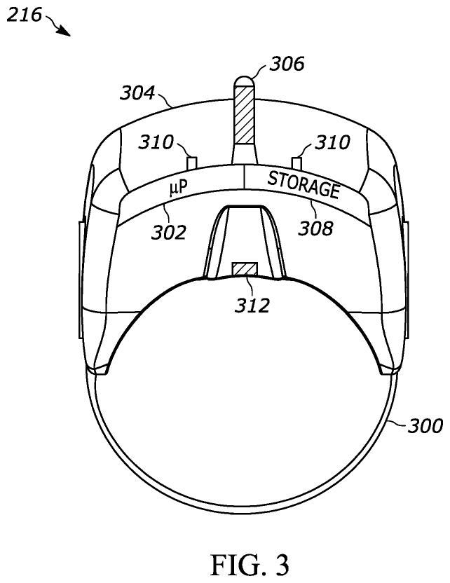

Now describing FIG. 3, it shows a top plan view of a headset such as the headset 216 consistent with present principles. The headset 216 may include a housing 300, at least one processor 302 in the housing 300, and a non-transparent or transparent “heads up” display 304 accessible to the at least one processor 302 and coupled to the housing 300. The display 304 may for example have discrete left and right eye pieces as shown for presentation of stereoscopic images and/or 3D virtual images/objects using augmented reality (AR) software, virtual reality (VR) software, and/or mixed reality (MR) software.

The headset 216 may also include one or more forward-facing cameras 306. As shown, the camera 306 may be mounted on a bridge portion of the display 304 above where the user's nose would be so that it may have an outward-facing field of view similar to that of the user himself or herself while wearing the headset 216. The camera 306 may be used for computer vision, image registration, spatial mapping, etc. to identify gestures as described herein and/or to track movements within real-world space. However, further note that the camera(s) 306 may be located at other headset locations as well. Further note that in some examples, inward-facing cameras 310 may also be mounted within the headset 216 and oriented to image the user's eyes for eye tracking while the user wears the headset 216 consistent with present principles.

Additionally, the headset 316 may include storage 308 accessible to the processor 302 and coupled to the housing 300, a microphone 312 for detecting audio of the user speaking as part of a virtual conference, and still other components not shown for simplicity such as a network interface for communicating over a network such as the Internet and a battery for powering components of the headset 216 such as the camera(s) 306. Additionally, note that while the headset 216 is illustrated as a head-circumscribing VR headset, it may also be established by computerized smart glasses or another type of headset including other types of AR and MR headsets. For example, the headset may be established by an AR headset that may have a transparent display that is able to present 3D virtual objects/content.

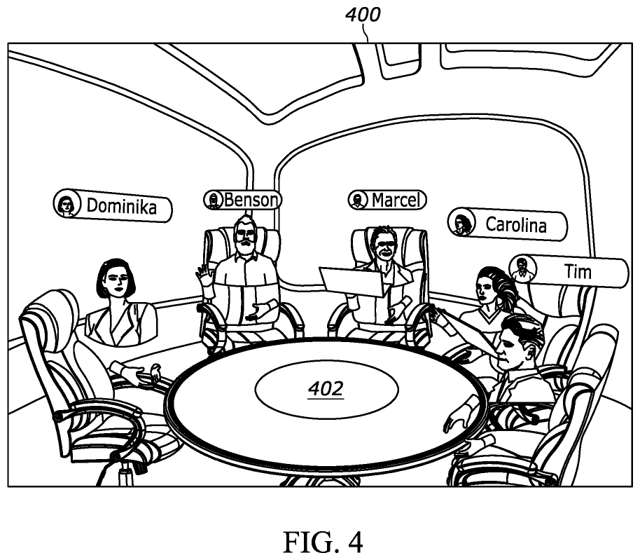

Now in reference to FIG. 4, suppose various people would like to conference with each other in a virtual conference environment (e.g., metaverse environment) where each participant wears a headset like the headset 216 described above to immerse themselves in a virtual conference in which the participants are virtually placed into a same virtual space. In the present example, the virtual space is a virtual conference room 400 and, as may also be appreciated from FIG. 4, each participant is represented within the virtual space as a respective graphical avatar/virtual character. The avatar or virtual character may be a computer-generated representation of the real-world physical characteristics of the respective participants themselves, and/or may be representations of the participants based on whatever other avatar or graphical character they select that might be unrelated to their real-world physical characteristics (e.g., selecting an avatar found on the Internet, a virtual fictional character from a motion picture or video game or VR simulation, etc.). Or in other example implementations, the respective representations of the participants in the virtual space may include respective real-time camera video streams of the actual real-world faces of the first, second, and third participants, which may or may not be overlaid on fictional/graphical avatar bodies in the virtual space to also help represent the respective participants. Regardless, it may be appreciated that even though the participants themselves may be remotely-located from each other by great distances such as tens of miles or more, their respective client devices (e.g., headsets) may be used to immerse the participants in the virtual space in which they all appear to be located together and, through VR/AR/MR/metaverse software, can interact with each other audibly and visually within the virtual space as if they were actually co-located within the same real-world space.

Note that the virtual space itself, as well as audio and video streams of each participant for representation within the virtual space, may be transmitted in real time between devices over the Internet or another network, possibly as routed through a remotely-located coordinating server (or other coordinating device such as one of the client devices themselves) that may be creating and hosting/maintaining the virtual space itself for streaming back to the client devices of the participants. Thus, the audio and video data, and possibly other data such as inertial sensor data, may be transmitted from each client device to the server. The server may then translate real world motions and gestures performed by each participant, as identified through video from each participant's camera and/or movements indicated by tilt/inertial sensors, into corresponding similar movements of the participant's virtual character within the virtual space. Again note that AR, VR, MR, and/or metaverse software may be used to do so.

Thus, in certain specific example implementations, cameras may be used that are located on each participant's client device, and/or that are located elsewhere within each participant's local environment and have a field of view of the respective participant's face (e.g., where the camera on the participant's headset may not have such a view of the participant's face). Computer vision may then be executed using images of the respective participant's face to detect particular mouth shapes and movements as that participant speaks, which can then be translated in real time into corresponding same or similar mouth movements of the respective participant's virtual character or avatar within the virtual space for representation to other participants in the virtual space. Gesture recognition and/or computer vision may also be used to identify arm gestures and other body movements shown in real-world images of each participant for the mimicking by the respective participant's virtual character. On-person sensors such as electrodes and inertial sensors located elsewhere on each participant (e.g., at various locations on their arms and torso) but that are still in communication with the participant's client device may also be used to identify arm movements and other types of movements for mimicking in the virtual space. Further note that audio of each participant speaking, as may be picked up by a local microphone on the respective participant's client device, may also be transmitted to other participants in real time so the other participants can hear what the other person is saying as part of the virtual conference.

As may also be appreciated from the example of FIG. 4, the virtual character associated with each respective participant is shown sitting around a virtual conference table 402 placed within the virtual space 400. Also note that the perspective shown in FIG. 4 is understood to be the perspective of a first participant named Mark according to a virtual location within the space 400 into which Mark's virtual character has been placed. Thus, note that while Mark's virtual character is not shown in FIG. 4, the other conference participants may be able to see his virtual character from their own respective different virtual perspectives in the space 400 according to their own respective virtual locations. Thus, real-world locations of the participants with respect to each other are mimicked as if the participants were all located within the same real-world space.

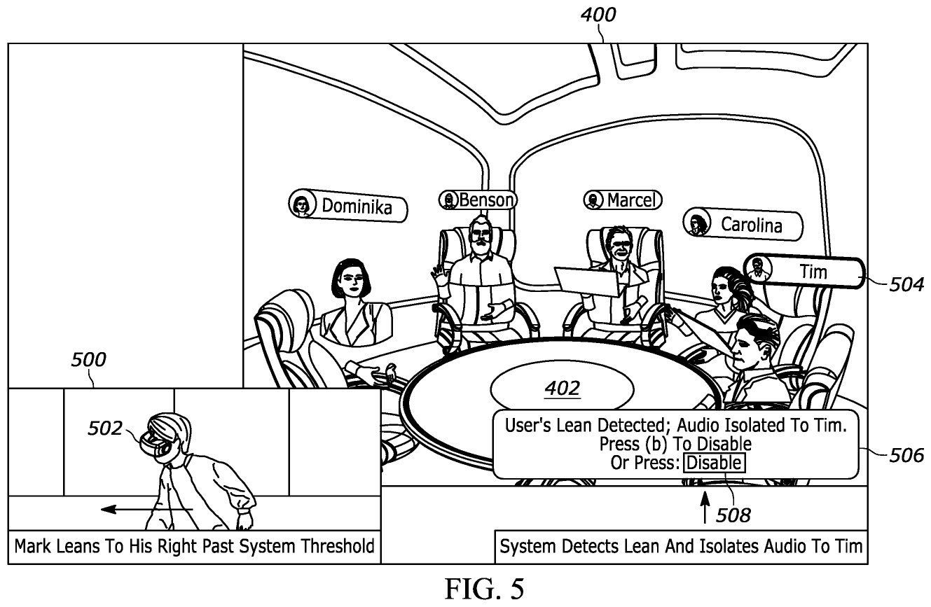

Now suppose that Mark leans his head, neck, and torso to the right in the real world while participating in the virtual conference, which may translate into Mark's virtual character leaning toward a participant named Tim according to Tim's virtual location within the virtual space 400. Inset illustration 500 as shown in FIG. 5 shows Mark as he leans to the right in the real world while he wears a VR headset 502 that detects the lean based on, for instance, input from a gyroscope on the headset 502. As also noted via the inset 500, in some specific examples a threshold tilt angle may be identified by the device before triggering an isolated audio interaction between Mark and Tim to thus help avoid false positives where Mark might unintentionally trigger an isolated audio interaction when Mark meant to speak to all participants instead. The threshold may therefore be sufficient for avoiding such false positives, and as such the threshold may be ten degrees of tilt or more.

Then, as also illustrated in FIG. 5, once Mark's client device (or another device such as the coordinating server) detects Mark's real-world lean to the right, audio from Mark's microphone on his client device may be transmitted to Tim's client device but not those of other participants of the virtual conference, thereby isolating Mark's audio to have a side conference or sub-conference to speak with Tim where other participants cannot hear what they are saying.

Moreover, in certain examples based on Mark's lean, the audio interaction between Mark and Tim may be isolated but still bi-directional so that Tim's audio may also only be streamed to Mark's client device during the isolated audio interaction and not to other participating client devices. However, in other examples Tim may be required to perform his own lean or other gesture to have his audio isolated to Mark and otherwise his audio may be presented to all other participating client device even if Mark is still leaning toward Tim.

Also note that in some examples, spatial and/or binaural three-dimensional (3D) audio may be executed for presentation of each participant's audio during the isolated audio interaction. So, for example, 3D audio may be executed at Tim's client device using left/right speakers as located on headphones or ear buds that Tim is wearing during the virtual conference. Tim may therefore hear Mark speak from a direction of Mark's virtual location within the space 400 and, in the present example, the audio may be louder in Tim's left ear/speaker than his right ear/speaker since Mark's virtual character is to the left of Tim's virtual character within the space 400.

Still in reference to FIG. 5, further note that responsive to detecting Mark's lean toward Tim, Tim's name label 504 may be highlighted with a yellow glowing halo effect (as presented on the display of Mark's headset) while the name labels for other users as also represented to Mark in the virtual space 400 may remain the same as they did according to FIG. 4. Thus, the halo effect may serve as an indication to Mark that his lean has resulted in an isolated audio mode or whisper mode being triggered in which his audible input will be streamed to Tim but not to other participants.

Additional indications may also be presented to Mark to indicate that Mark's client device has entered the isolated audio mode. One such indication may be the notification 506 shown in FIG. 5. As shown, the notification 506 may indicate via text that Mark's lean has been detected and that Mark's audio stream has been isolated to presentation at Tim's device.

In certain examples, the notification 506 may also include instructions to press the B button on Mark's keyboard to exit the isolated audio mode and go back to full audio conference mode where Mark's audible input is transmitted to all conference participants (e.g., even if Mark continues to lean). However, further note that in some examples the notification 506 may also include a graphical selector 508 so that Mark may air tap the selector 508 according to its represented location in the virtual space 400 (or otherwise select the selector 508) as another way to exit the isolated audio mode and go back to full audio conference mode. The air tap gesture itself that Mark might provide may be detected using computer vision and input from a camera on Mark's headset to identify Mark's hand as moving toward and tapping in real space at a corresponding real world location mapped to the location of the selector 508 within the virtual space 400.

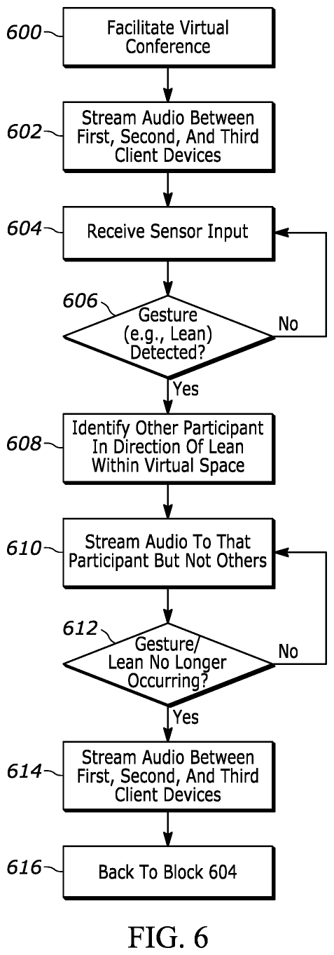

Referring now to FIG. 6, it shows example logic consistent with present principles that may be executed by a device such as the system 100, one or more headsets or other client devices being used for a virtual conference, and/or a remotely-located coordinating server in any appropriate combination. Note that while the logic of FIG. 6 is shown in flow chart format, other suitable logic may also be used.

Beginning at block 600, the device may facilitate a virtual conference by transmitting A/V content, metaverse content, sensor data, conference metadata, etc. between conferencing devices, such as a client device transmitting its A/V data to others and receiving the A/V data of other participants for local presentation. Or at block 600 a coordinating server may route such data between client devices, control one or more conferencing-related GUIs as presented locally at the client devices of the respective participants, control the virtual space itself in real time, etc. Thus, block 602 denotes that audio of each participant speaking is transmitted between at least first, second, and third client devices of respective first, second, and third participants so that each participant can hear the other participants speaking as part of the virtual conference.

From block 602 the logic may proceed to block 604 where the device may receive sensor input for detecting whether a lean or other gesture for entering an isolated audio mode has been performed as described above. Thus, input from a camera or inertial sensor such as a gyroscope or accelerometer may be received at block 604 to then determine, at decision diamond 606, whether a lean or other gesture has been detected. Note here that other example gestures besides a lean may include a head tilt in the virtual direction of the other participant for which audio isolation is desired (which may also be triggered by a tilt of more than ten degrees), or even a finger gesture pointing at the other participant or a “come closer” repeated index finger wave from farther from the gesturing user to closer to the gesturing user. Thus, note here that isolated audio interactions need not be limited to participants represented in the virtual space as being immediately next to each other in the virtual space and may also be used for isolated audio interactions between participants that are at other virtual locations with respect to each other, such as two participants virtually located/spaced across the virtual conference 402 table shown in FIGS. 4 and 5.

A negative determination at diamond 606 may cause the logic to revert back to block 604 to continue receiving sensor input to monitor for gestures for which an isolated audio mode may be entered. However, an affirmative determination may instead cause the logic to proceed to block 608 where the device may, if it has not done so already, identify another participant in the virtual direction of the lean (or other gesture) within the virtual space according to a current virtual location of the gesturing participant themselves.

From block 608 the logic may then proceed to block 610 where the device may stream audio in an isolated audio mode to the other participant to which the gesture was directed. Thus, audio may be selectively presented to that other participant via that participant's own client device, but not other participants. And again note that binaural audio may be used for presentation of the audio.

Thereafter the logic may proceed to decision diamond 612 for the device to determine whether the lean or other gesture is no longer occurring. This too may be determined based on sensor input that continues to be received. Responsive to a negative determination at diamond 612 (the gesture is still occurring), the logic may revert back to block 610 and continue presenting audio in the isolated audio mode and then repeat the decision at diamond 612 until such time as an affirmative determination is made. And using the example of FIG. 5 above, an affirmative determination itself may be made based on detecting the leaning participant (Mark) leaning back to an upright position rather than toward Tim's virtual location in the virtual space.

Once an affirmative determination is made at diamond 612, the logic may next proceed to block 614. At block 614 the device may begin streaming the gesturing participant's audio to all participants again in a full audio conference mode. From block 614 the logic may proceed to block 616 where the logic may revert back to block 604 and proceed again therefrom.

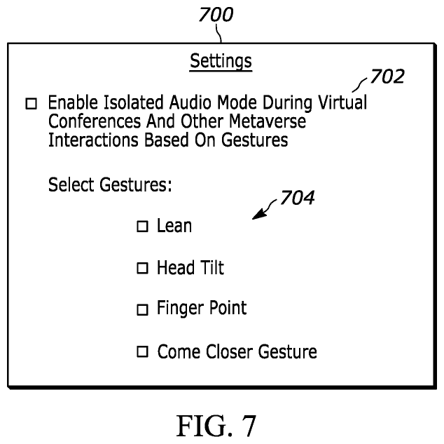

Continuing the detailed description in reference to FIG. 7, it shows an example settings graphical user interface (GUI) 700 that may be presented on the display of a client device or even the display of a server to configure one or more settings of a conferencing system or metaverse system to operate consistent with present principles. For example, the GUI 700 may be presented on the display of the device undertaking the logic of FIG. 6, the display of an end-user's own client device, and/or the display of a system administrator's device.

The settings GUI 700 may be presented to set or enable one or more settings of the device or system to operate consistent with present principles. The GUI 700 may be reached by navigating a main settings menu of the device or its operating system, or a settings menu of a particular virtual conferencing or metaverse application that may be used consistent with present principles. Also note that in the example shown, each option to be discussed below may be selected by directing touch or cursor or other input to the respective check box adjacent to the respective option.

Accordingly, as shown in FIG. 7, the GUI 700 may include an option 702 that may be selectable a single time to set or configure the device, system, software, etc. to undertake present principles for multiple future virtual conferences, such as executing the functions described above in reference to FIGS. 4 and 5 and executing the logic of FIG. 6 for different virtual conferences in the future.

The GUI 700 may also include respective options 704 to select one or more particular gestures to detect for triggering entrance into an isolated audio mode as described herein. As shown in FIG. 7, example gestures may include leaning, a head tilt, a finger point toward the other participant, and a come closer gesture.

Moving on from FIG. 7, note that while the example virtual space described above is a virtual conference room, other types of virtual spaces may also be used consistent with present principles. For instance, other virtual spaces that may be used include a virtual outdoor park, a virtual living room of a virtual personal residence, or even a computer-generated video game scene where the avatars of the gamers meet to speak with each other.

Also note that present principles may be performed even for non-headset participants, such as participants using a smartphone, laptop, or tablet computer to view a virtual space via that device's display.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. An apparatus, comprising:
at least one processor; and
storage accessible to the at least one processor and comprising instructions executable by the at least one processor to:
facilitate a virtual conference between first, second, and third participants, the first, second, and third participants being remotely located from each other, the virtual conference placing respective representations of the first, second, and third participants into a same virtual space;
determine that the first participant gestures toward the second participant according to locations of the first and second participants in the virtual space;
based on the determination, stream audio of the first participant speaking from a first client device to a second client device of the second participant but not stream the audio of the first participant speaking from the first client device to a third client device of the third participant.

2. The apparatus of claim 1, wherein the instructions are executable to:
prior to the determination, stream audio from each of the first, second, and third client devices between each other so that the first, second, and third participants are able to hear each other speak as part of the virtual conference.

3. The apparatus of claim 1, wherein input from at least one inertial sensor is used to make the determination.

4. The apparatus of claim 1, wherein the at least one inertial sensor comprises a gyroscope.

5. The apparatus of claim 4, comprising the gyroscope.

6. The apparatus of claim 1, wherein the apparatus comprises a server that coordinates the transmission of audio and video streams between the first, second, and third client devices as part of the virtual conference.

7. The apparatus of claim 1, wherein the apparatus comprises the first client device.

8. The apparatus of claim 1, wherein the respective representations of the first, second, and third participants comprise respective avatars of the first, second, and third participants.

9. The apparatus of claim 1, wherein the respective representations of the first, second, and third participants comprise respective camera streams of the respective faces of the first, second, and third participants.

10. The apparatus of claim 1, wherein the virtual space comprises a virtual conference room into which the respective representations are placed.

11. The apparatus of claim 10, wherein the virtual conference room forms part of a virtual reality (VR) environment into which the respective representations are placed.

12. A method, comprising:
facilitating, using an apparatus, a virtual conference between first, second, and third participants, the first, second, and third participants being remotely located from each other, the virtual conference placing respective representations of the first, second, and third participants into a same virtual space;
determining that the first participant performs a gesture in relation to the second participant according to locations of the first and second participants in the virtual space;
based on the determining that the first participant performs the gesture in relation to the second participant according to the locations of the first and second participants in the virtual space, streaming first audio of the first participant speaking from a first client device to a second client device of the second participant but not streaming the first audio of the first participant speaking from the first client device to a third client device of the third participant.

13. The method of claim 12, wherein the gesture comprises leaning toward the second participant according to the locations of the first and second participants in the virtual space.

14. The method of claim 13, comprising:
determining that the first participant is no longer leaning toward the second participant; and
responsive to determining that the first participant is no longer leaning toward the second participant, streaming second audio of the first participant speaking from the first client device to both the second and third client devices.

15. The method of claim 12, comprising:
determining, based on input from a camera, that the first participant performs the gesture in relation to the second participant according to locations of the first and second participants in the virtual space.

16. The method of claim 12, wherein the virtual space forms part of a mixed reality (MR) environment into which the respective representations are placed.

17. The method of claim 12, wherein the respective representations of the first, second, and third participants comprise respective virtual characters respectively associated with the first, second, and third participants.

18. At least one computer readable storage medium (CRSM) that is not a transitory signal, the at least one computer readable storage medium comprising instructions executable by at least one processor to:
facilitate, using an apparatus, a virtual conference between first, second, and third participants, the first, second, and third participants being remotely located from each other, the virtual conference placing respective representations of the first, second, and third participants into a same virtual space;
determine that the first participant performs a gesture in relation to the second participant according to locations of the first and second participants in the virtual space;
based on the determination that the first participant performs the gesture in relation to the second participant according to the locations of the first and second participants in the virtual space, selectively provide first audio of the first participant speaking from a first client device to a second client device of the second participant but not provide the first audio of the first participant speaking from the first client device to a third client device of the third participant.

19. The CRSM of claim 18, wherein the gesture comprises leaning toward the second participant according to the locations of the first and second participants in the virtual space.

20. The CRSM of claim 18, wherein the instructions are executable to:
determine that the first participant is no longer performing the gesture toward the second participant according to the locations of the first and second participants in the virtual space; and
responsive to the determination that the first participant is no longer performing the gesture in relation to the second participant according to the locations of the first and second participants in the virtual space, provide second audio of the first participant speaking from the first client device to both the second and third client devices.
